(19) United States
(12) Patent Application Publication
(10) Pub. No.: US 2010/0147976 A1
(43) Pub. Date: Jun. 17, 2010

(54) BOTTOM FEED FUEL INJECTORS

(75) Inventors: Jonian Nikolov, Melbourne (AU); Eric Gaynor, Melbourne (AU); Paul Baker, Melbourne (AU); John Taylor Martin, Melbourne (AU)

Correspondence Address: J. Rodman Steele;Novak Druce & Quigg LLP, 525 Okeechobee Blvd, Suite 1500, West Palm Beach, FL, 33401, US

(73) Assignee: Interlocking Buildings PTY LTD., Melbourne, Victoria (AU)

(21) Appl. No.: 12/598,089

(22) PCT Filed: May 1, 2008
(86) PCT No.: PCT/AU08/00605

§ 371 Date: Oct. 29, 2009

(30) Foreign Application Priority Data
May 1, 2007 (AU) 2007902274

(51) Int. Cl. F02M 51/06; F02M 69/46

(52) U.S. Cl. 239/585.1

(57) ABSTRACT

A liquid fuel injector connected to the fuel line manifold and return line manifold by plastic tubing, standard petrol fittings, or high pressure hosing so aiding ease of installation, each injector having a separate inlet and return line to assist in fuel temperature control. The injectors are designed to assist in keeping the temperature of the fuel as low as possible with the injector coil not being cooled by the fuel, but by ambient air.

### FIELD OF THE INVENTION

This invention relates to liquid fuel injectors more particularly for use with high vapour pressure fuel such as liquid petroleum gas or a lower vapour pressure fuel such as petrol.

BACKGROUND OF THE INVENTION

The invention will generally be discussed in relation to the operation of a liquified petroleum gas fuelled vehicle with petrol (gasoline) as a second fuel however the invention is not limited to the use of these two fuels. A mixed charge of differing fuels can be used.

It is particularly desirable on the grounds of economics to have only one set of fuel injectors for any two fuels in an engine, or a mix of the two fuels.

The present invention provides an economical arrangement whereby such an engine can be provided with bottom feed injectors of a size equal to or smaller than commonly used petrol injectors which are top fed and substantially smaller than bottom feed injectors commonly in use as they do not sit in a specially designed pod, or series of pods, constituting a fuel rail.

It has been proven that top feed injectors are unsuitable for use with high vapour pressure fuel such as LPG in that the liquid tends to vaporise and form bubbles thus preventing the efficient injection of the fuel in the liquid phase into either the manifold or direct into the cylinder.

While the invention is particularly directed to an injector for LPG the injector is also suitable for petrol. Thus with a dual fuel vehicle the same injector will operate on both fuels or a mixture of fuels.

The size of known bottom feed injectors in their pods was (or is?)adverse to their desirability in engine design as a consequence of the space occupied by these bottom feed injectors, plus the larger seating holes in the inlet manifold, and their fuel rail which is normally of rigid construction.

### BRIEF STATEMENT OF THE INVENTION

There is provided according to the invention a bottom feed liquid fuel injector, the fuel being fed by arms to the bottom of the injector whereby there is a continuous flow of liquid fuel through the bottom of the injector from one arm to the other, an electromagnetic coil controlling a pintle, said coil being isolated from the liquid fuel flow and cooled by ambient air.

The bottom feed injectors allow any vapour which has formed to rise above the injection orifice level and be removed by the fuel flow.

It is realised substantial heat can be generated by the coils, and in this invention the coil is not intended to be cooled by the fuel flow but is designed to be sufficiently cooled by ambient air.

### SUMMARY OF THE INVENTION

Prior to this invention the size of bottom fed injectors in their pods was and is adverse to their desirability in engine design as a consequence of the space occupied by these bottom feed injectors and their fuel rail which is normally of rigid construction. The injectors disclosed are approximately half the height of current 85 to 90 mm top feed injectors and are approximately the same diameter.

In addition, the nozzle size of the pod containing the actual bottom of the feed injector was typically 19 mm in diameter, versus the 14 mm holes commonly drilled in the inlet manifold of an engine. A consequence is that to install commonly used bottom feed injectors the inlet manifold has to be removed, holes of 19 mm or otherwise selected diameters drilled, the manifold carefully cleaned and reassembled to the engine.

The bottom feed injectors disclosed by this invention do not require to be placed in a housing or pod, the outer shell of the injector serving that function. The fuel is fed to the bottom of the injector and removed therefrom by arms which are both rigid and barbed in the desired embodiment, to which the plastic tubing desired to be used to convey the fuel is connected. The fuel lines may be of metal constructed and plastic coated for thermal efficiency.

Connection of the fuel lines to the arms can be by a positive mechanical screw on fitting giving maximum assurance that the fuel will not escape from the fuel lines. The arms can be connected to the injector body at any convenient angle giving greater flexibility of installation.

The angle of the arms and the design of the flow path for the fuel inside the injector can assist the control of vapour formation and the flow of any vapour bubbles in much the same manner as a cyclone.

The nozzle of the injector can be relatively small at 8 or 9 mm in diameter and can be fitted with a collar to ensure that the injector is snug fit in the holes provided in the inlet manifold by the engine manufacturer. This aids in rapidity and economy of assembly.

Liquid petroleum gas (LPG) is a mixture of light petroleum hydrocarbons (predominately of propane and butane) which have been stored under moderate pressure remains in a liquid state and when released to atmosphere at normal ambient temperatures rapidly changes state to a gas. LPG can vary from almost all propane to nearly all butane and mixtures in between. Lighter factions, such as methane and ethane can have the effect of raising the vapour pressure of the fuel. LPG has the potential top be a readily available low cost alternative fuel to pr]=petrol for automotive and other engines and can be used in conjunction with petrol, methanol to ethanol dual fuel engines. Because of the higher compression ratios that can be employed t=with LPG it makes a good match with lower vapour pressure fuels such as methanol or ethanol that can also use higher compression rations than those normally used with petrol, but these fuels have markedly lower vapour pressures than LPG.

The bottom feed injectors disclosed herein are designed so as to be usable with all of the above fuels or a mixture of them.

With dual fuel systems that inject the fuel in the liquid state viae bottom feed injectors as in Australian Patent 6547561 “A Method of Fuel Injection” and 647857 “Dual Fuel Injection System,” there exists a problem of the size of the injectors used prior to this disclosure and rigid fuel rails delivering fuel to the injector and removing unused fuel, the flow rate being much greater than the usage volumes which assists in keeping the fuel in the liquid state.

It is of assistance and is specified as the desired option in this invention that to deliver liquid LPG to the injecting orifice of the injector, the injectors be of the bottom feed type and allow any vapour which has formed to rise above the injection orifice level and be removed by the fuel flow.

It is preferred in the invention to use tubular barbed arms of metal or composite materials delivering from strong, but flexible plastic tubing preferably meeting Australian/New Zealand Standard 1425:2033 requirements the required fuel flow to the injectors. The fuel can flow in either direction from the inlet to the outlet arm.

The present invention is directed to a fuel system employing low vapour fuels which fuels are sensitive to heat. Substantial heat can be generated by the coils in the injectors and in this invention the coil is not intended to be cooled by the fuel flow, but is designed to b sufficiently cooled by ambient air.

For low emissions at idle the injector has to be capable of opening and closing rapidly compared to existing petrol injectors operation from 200 to 400 hertz (Hz). Whereas 400 Hz will give an adequate performance best results are obtained with frequencies from 500 to 1,000 Hz, preferably approaching 1,000 Hz.

The pressures against which the injectors must operate in the range from 200 kPa up to 3,000 kPa.A normal operating range may be form 300 kPa to 1,500 kPa. A substantial portion of the total pressure is the result of the LPG being subject to heat input.

Accordingly, the separation of the fuel and heat sources. Plus insulation against heat, is important and is illustrated by the design which has the coil above the fuel flow through the injector and the use of plastic fuel lines.

### BRIEF DESCRIPTION OF THE DRAWINGS

FIG. 1 is a view of one form of the injector,

FIG. 2 is a sectional view of an injector,

FIG. 3 is a view of a further form of an injector with the coil mounted further from the circulating fuel, and

FIG. 4 is a further embodiment showing the arms extending at an angle from the bottom of the injector.

### DESCRIPTION OF THE INVENTION

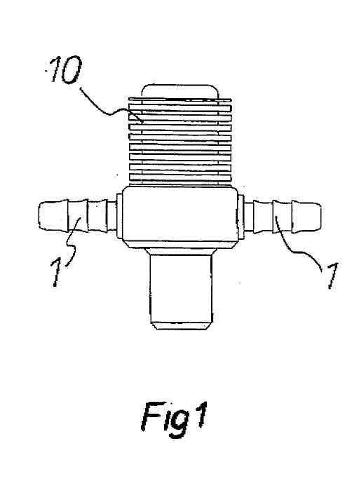

FIG. 1 shows a form of the injector showing the arms and the cooling fins on the body for the cooling of the coil.

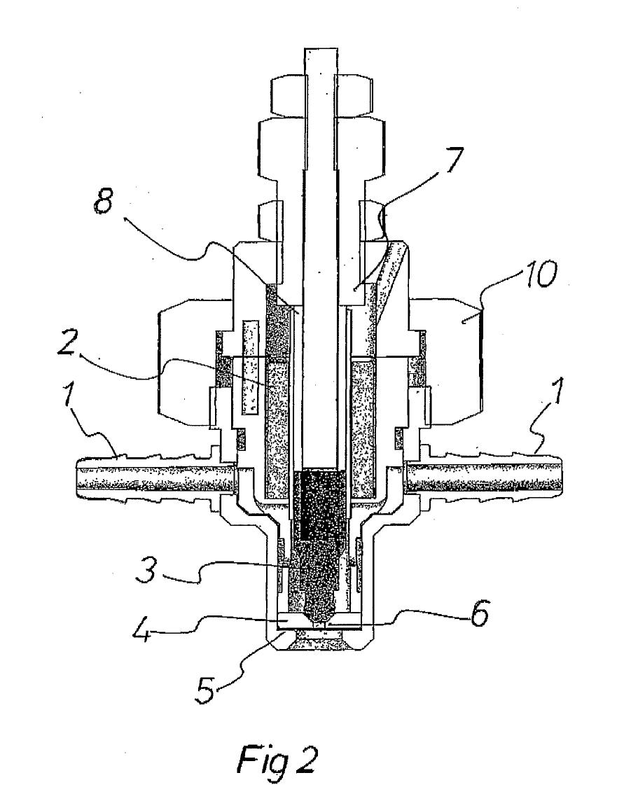

FIG. 2 is an illustration of a form of the invention showing the major components of the bottom feed injector system including the barbed arms, which in this embodiment are shown as barbed. The barbed inlet and outlet arms 1 can be placed at any convenient angle to assist connection to the flexible plastic tubing used to convey the fuel and to induce a flow motion within the injector which motion will assist with the removal of vapour bubbles from the stream of fuel and in particular ensure there is liquid only at the injector tip to be injected into the inlet manifold or cylinder of the engine.

The coil 2 is sized to obtain a frequency of 1,000 Hz and is placed above the fuel flow to ensure that the temperature rise in the liquid fuel is restricted to the greatest possible degree. The coil is placed so that the external body of the injector, in contact with the ambient air, will assist in the cooling of the injector to the maximum possible degree. Cooling fins 10 on the outside of the injector can be employed to assist the cooling.

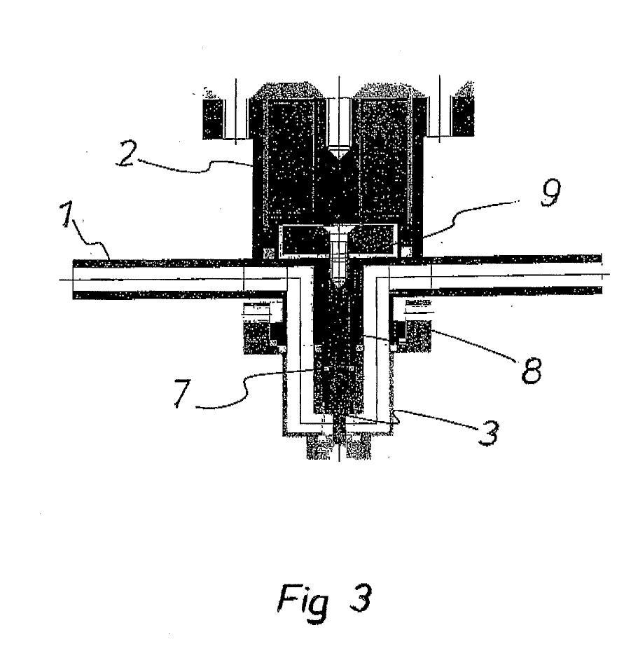

The pintle 3 has a size and weight which allows the Coil to move it at the desired frequency against the fuel pressure and the seating force of the return spring 8 which force can be adjusted by an adjustable collar 7. The pintle in FIG. 2 is hollow and in FIG. 3 is solid. In this embodiment the arms are not shown as barbed.

The seat 4 for the pintle is of standard construction. When the pintle is raised towards the coil fuel can flow through the nozzle 6 and the appropriate spray pattern is achieved by the use of a deflector plate 5.

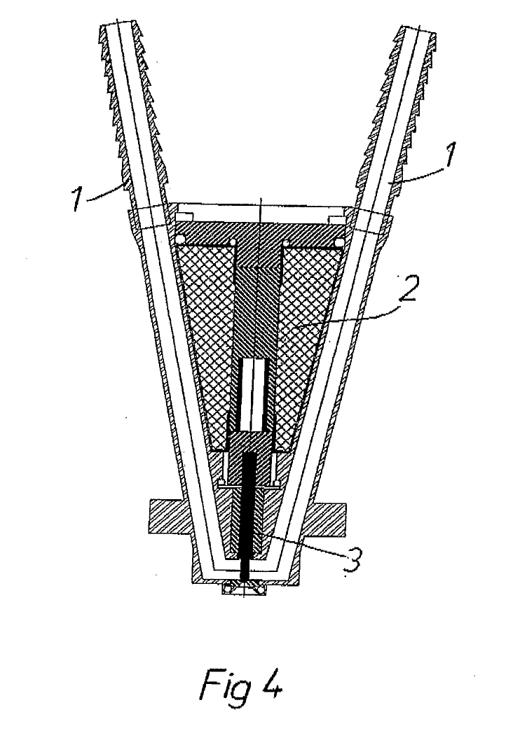

Turning now to FIG. 4, a further embodiment illustrates an example of the arms 1 extending at an angle from the lower end of the injector, the arms passing upwardly alongside the body of the injector. Fins would be provided around the body of the coil, the arms passing through vertical openings in the fins, the heat from the coil being dissipated trough the fins.

Thus it can seen that there is provided according to the invention an economical method of manufacturing a liquid fuel supply system for an internal combustion engine utilising bottom feed injectors, such injectors being connected to the fuel inlet manifold and return line manifold by either flexible plastic tubing, or standard petrol fittings coated in plastic for heat insulation, or high pressure hosing so aiding ease of installation. Each injector has a separate inlet and return line to further assist in fuel temperature control, each injector is not cooled by the fuel but by ambient air.

The injectors are designed to keep the fuel liquid flow at the tip of the injector for injection directly into the inlet manifold or the cylinder of the engine, whereby any bubbles which may form rise from the injection orifice to be carried away by the fuel flow.

Although various forms of the invention have been described it is to be noted the invention is not to be limited thereto but can include variations and modifications falling within the spirit and scope of the invention.

1. A bottom feed liquid fuel injector, the liquid fuel being fed by an inlet arm to the bottom of the injector whereby liquid fuel flows continuously across said injector adjacent an injection nozzle to an outlet arm, a pintle controlling flow through said injector nozzle, an electromagnet coil controlling the operation of said pintle, said coil being isolated from said liquid fuel flow and cooled by ambient air.

2. A bottom feed liquid fuel injector as defined in claim 1 wherein said coil has external fins for air cooling or which may be enclosed in a separate cooling system.

3. A bottom feed liquid fuel injector as defined in claim 1 wherein the coil is positioned on the injector remote from the bottom of the injector and above the transverse or lateral flow of the fuel.

4. A bottom feed liquid fuel injector, the injector including a pintle controlling the injection of the liquid fuel though an injection nozzle, an electromagnetic coil controlling the pintle, the electromagnetic coil being cooled by ambient air, an inlet for the liquid fuel above the injection nozzle, an outlet above the injection nozzle whereby liquid fuel flows continuously across above the injection nozzle whereby any vapour which forms in the vicinity of the injection nozzle rises and is removed by the liquid fuel flow across the injector.

5. A bottom feed liquid fuel injector as defined in claim 4 wherein each of the inlet and outlet and arms are connected to metal tubes covered in plastic insulation.

6. A bottom feed liquid fuel injector, said injector including an inlet for the liquid fuel , an outlet for the liquid fuel, an injection nozzle, a pintle for controlling the fuel injection through the said nozzle, the fuel flowing continuously across the pintle and nozzle from the inlet to the outlet, an electromagnetic coil isolated from the liquid fluid flow controlling the operation of the pintle, each said inlet and outlet comprising a barbed arm adapted to be connected to a flexible tube to convey the liquid fuel.

7. A bottom feed liquid fuel injector as defined in claim 5 wherein said arms extend outwardly from the bottom of the injector.

8. A bottom feed liquid fuel injector as defined in claim 5 wherein said arms extend outwardly at an angle from the bottom of the injector toward the top thereof to permit assembly of the injector in a confined area providing great flexibility in installation.

9. A bottom feed liquid fuel injector as defined in claim 5 wherein the outer shell of the injector serves the purpose of a housing or pod assisting the fuel in remaining isolated from the heat of the coil.
